(19) United States
(12) Patent Application Publication
(10) Pub. No.: US 2021/0103609 A1
(43) Pub. Date: Apr. 8, 2021

(54) SYSTEMS AND METHODS TO FACILITATE GENERATION OF PERSONALIZED DIGITAL CONTENT - "CONTENT CONTROLLER"

(71) Applicant: DM-DSP, LLC, Mill Valley, CA (US)

(72) Inventor: George William Daly, Mill Valley, CA (US)

(21) Appl. No.: 17/062,343

(22) Filed: Oct. 2, 2020

Related U.S. Application Data
(60) Provisional application No. 62/910,877, filed on Oct. 4, 2019.

(51) Int. Cl. G06F 16/435; G06F 9/451; G06F 16/438

(52) U.S. Cl. CPC G06F 16/435; G06F 16/438; G06F 9/451

(57) ABSTRACT

Disclosed herein, among other things, are systems and methods to facilitate generation of personalized digital content. A display is provided on a graphical user interface (GUI) of at least one user device, the display including an interactive portion for the user to select percentages of a plurality of digital content types from at least one server. A user selection is received corresponding to two or more percentages according to two or more digital content types. Digital content of the two or more digital content types is retrieved from a database associated with the at least one server. Personalized digital content is generated based on the two or more digital content types according to the two or more percentages by stitching the retrieved digital content according to the user selection. The personalized digital content is transmitted to at least one user device.

### CLAIM OF PRIORITY

This application claims the benefit under 35 U.S.C. § 119(e) of U.S. Provisional Patent Application Ser. No. 62/910,877, filed Oct. 4, 2019, which is hereby incorporated by reference herein in its entirety.

### FIELD OF THE INVENTION

The present invention relates generally to the field of data processing. More specifically, the present disclosure relates to systems and methods to facilitate selection and generation of Personalized Digital Content.

### BACKGROUND OF THE INVENTION

Conventional digital content services providing digital content in different formats to users are hugely popular. The digital audio content may include spoken words, conversations, podcasts, songs, music, etc. Examples of such audio digital content services are “Spotify™”, “Apple Music™”, etc. as well as text and picture and video digital content such as “Facebook™”, “Instagram™™”, and “Youtube™”, etc. The user may listen and/or view at least one content type at a time from the various content options available from any digitally stored audio or video or text service that has a plurality of “contents.”

However, there are several deficiencies in the conventional content services operate. For example, the conventional digital content services do not allow the user to listen or view multiple pieces of mixed content serially and/or synchronously in a cycle according to user preferences. Further, conventional digital content services do not allow the user to modify the duration of this cycle. In addition, the digital content is pre-stored in the conventional digital content services and therefore may not be in accordance with the interest of the user.

Therefore, there is a need for improved systems and methods to facilitate selection and generation of Personalized Digital Content that may overcome one or more of the above-mentioned problems and/or limitations.

### SUMMARY

This summary is provided to introduce a selection of concepts in a simplified form, here applied to Sound/Music/Talk, that are further described below in the Detailed Description. This summary is not intended to identify key features or essential features of the claimed subject matter. Nor is this summary intended to be used to limit the claimed subject matter's scope, which extends to text, pictures and audio/video.

The present subject matter provides for user selection of content to be delivered to the user's personal device. An interface is provided on the user's personal device to enable the selection. In one basic example, the interface is configured to provide for user selection between types of audio content, such as music and talk, and the user can select a percentage of each (such as 75% music and 25% talk), which is referred to herein as the user's “mix.” The user may also select a period of time for the mix, such as an hour, in some embodiments. The present subject matter then obtains the audio content and present the audio content to the user over the period of time using the mix (in this example, the user would receive 45 minutes of music and 15 minutes of talk content over the one hour cycle period). More complex examples are discussed below, such as providing for selection of video, photos, or other types of content to be added to or blended with the mix. The interface can be configured in a number of displays, including but not limited to a knob type display, equalizer-type sliders, pie charts, racks, or other displays that enable the user to interact with the display to select percentages of content and periods of time for delivering the selected percentages of content.

According to some embodiments, a method to facilitate the selection and generation of personalized digital content is provided. A processor provides a display on a graphical user interface (GUI) of at least one user device, the display including an interactive portion for the user to select percentages of a plurality of digital content types from at least one server. The processor receives a user selection from the at least one user device corresponding to two or more percentages according to two or more digital content types from the at least one server, wherein the two or more percentages of each content type have a sum of one hundred percent. The processor retrieves digital content of the two or more digital content types from a database associated with the at least one server, and generates a personalized digital content based on the user selection of the two or more digital content types according to the two or more percentages by stitching the retrieved digital content according to the user selection. The processor transmits the personalized digital content to the at least one user device configured to present the personalized digital content.

According to some embodiments, a computer system is provided including a processor and a non-volatile memory-based storage device connected to the processor comprising instructions that, when executed on the processor, configure the processor to provide a display on a graphical user interface (GUI) of at least one user device, the display including an interactive portion for the user to select percentages of a plurality of digital content types from at least one provider. The processor receives a user selection from the at least one user device corresponding to two or more percentages according to two or more digital content types from the at least one provider, wherein the two or more percentages of each content type have a sum of one hundred percent. The processor retrieves digital content associated with the two or more content types from a database associated with the at least one provider. The processor generates a personalized digital content based on the two or more content types according to the two or more percentages by stitching the retrieved digital content according to the user selection. The processor transmits the personalized digital content to the at least one user device configured to present the personalized digital content.

According to some embodiments, a method to facilitate a personalized digital content based on feedback is provided. The method includes receiving, using a processor, at least one sensor data from a plurality of sensors associated with at least one user device, and analyzing, using the processor, the at least one sensor data to obtain at least one response data. The processor modifies two or more periods corresponding to a duty cycle variable according to two or more content types based on the analyzing, and retrieves a digital content of two or more types from a database associated with at least one server. The processor generates a personalized digital content from the retrieved digital content based on the modifying and transmits the personalized digital content to the at least one user device.

According to some embodiments, a method to facilitate the selection and generation of personalized digital content is disclosed. Accordingly, the method may include a step of receiving, using a communication device, a duty cycle variable corresponding to two or more periods according to two or more content types from at least one user device. Further, the method may include a step of retrieving, using a storage device, a digital content associated the two or more content types from a database associated with a server. Further, the method may include a step of generating, using a processing device, a personalized digital content based on the two or more digital content types according to the two or more periods by stitching the two or more digital content types according to the duty cycle variable. Further, the method may include a step of transmitting, using the communication device, the personalized digital content to the at least one user device configured to present the personalized digital content.

According to some embodiments, a method to facilitate the selection and generation of personalized digital content is provided. Accordingly, the method may include a step of receiving, using a communication device, usage pattern data associated with two or more digital content types from at least one user device associated with at least one user. Further, the method may include a step of analyzing, using a processing device, the usage pattern data to determine a duty cycle variable corresponding two or more periods according to two or more digital content types. Further, the method may include a step of generating, using the processing device, a personalized digital content based on the analyzing. Further, the method may include a step of transmitting, using a communication device, the personalized digital content to the at least one user device configured to present the personalized digital content.

According to some embodiments, a method to facilitate the selection and generation of personalized digital content based on contextual rules is provided. Accordingly, the method may include a step of receiving, using a communication device, at least one sensor data from a plurality of sensors associated with at least one user device. Further, the method may include a step of analyzing, using a processing device, the at least one sensor data to obtain contextual data associated with a duty cycle variable according to two or more digital content types. Further, the method may include a step of retrieving, using a storage device, at least one contextual rule associated with the duty cycle variable according to the two or more digital content types. Further, the method may include a step of comparing, using the processing device, the contextual data with the at least one contextual rule. Further, the method may include a step of determining, using a processing device, a duty cycle variable according to the at least one contextual rule match. Further, the method may include a step of generating, using the processing device, personalized digital content based on determining. Further, the method may include a step of transmitting, using the communication device, the personalized digital content to the at least one user device.

According to some embodiments, a method to facilitate the merging of two or more digital content types is provided. Accordingly, the method may include a step of receiving, using a communication device, a duty cycle variable according to two or more digital content types from at least one user device associated with at least one user. Further, the method may include a step of analyzing, using a processing device, the two or more periods corresponding to the duty cycle variable to determine at least one breakpoint. Further, the method may include a step of merging, using the processing device, two or more digital format based on the analyzing. Further, the method may include a step of generating, using the processing device, a personalized digital content based on the merging. Further, the method may include a step of transmitting, using the communication device, the personalized digital content to the at least one user device.

According to some embodiments, a method to facilitate the selection and generation of personalized digital content based on metadata is provided. Accordingly, the method may include a step of receiving, using a communication device, a plurality of metadata associated with digital content from at least one user device. Further, the method may include a step of analyzing, using a processing device, the plurality of metadata to determine two or more digital content types according to two or more periods. Further, the method may include a step of determining, using the processing device, a duty cycle variable corresponding to the two or more periods based on the analyzing. Further, the method may include a step of generating, using the processing device, a personalized digital content based on determining. Further, the method may include a step of transmitting, using the communication device, the personalized digital content to the at least one user device.

According to some embodiments, a method to facilitate a personalized digital content based on feedback is provided. Accordingly, the method may include a step of receiving, using a communication device, at least one sensor data from a plurality of sensors associated with at least one user device. Further, the method may include a step of analyzing, using a processing device, the at least one sensor data to obtain at least one response data. Further, the method may include a step of modifying, using the processing device, two or more periods corresponding to a duty cycle variable according to two or more digital content types based on the analyzing. Further, the method may include a step of generating, using the processing device, a personalized digital content based on the modifying. Further, the method may include a step of transmitting, using the communication device, the personalized digital content to the at least one user device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2A shows a flowchart of a method to facilitate the selection and generation of personalized digital content, in accordance with some embodiments.

FIG. 2B shows a flowchart of a method to facilitate the selection and generation of personalized digital content, in accordance with some embodiments.

FIG. 2C shows a flowchart of a method to facilitate the selection and generation of personalized digital content, in accordance with some embodiments.

FIG. 3 shows a flowchart of a method to facilitate the selection and generation of personalized digital content, in accordance with some embodiments.

FIG. 4 shows a flowchart of a method to facilitate the selection and generation of personalized digital content based on contextual rules, in accordance with some embodiments.

FIG. 5 shows a flowchart of a method to facilitate the merging of two or more formats, in accordance with some embodiments.

FIG. 6 shows a flowchart of a method to facilitate the selection and generation of personalized digital content based on metadata, in accordance with some embodiments.

FIG. 7 shows a flowchart of a method to facilitate a personalized digital content based on feedback, in accordance with some embodiments.

FIG. 8 is a block diagram of a system to facilitate the selection and generation of a customized response based on a context, in accordance with some embodiments.

FIG. 9 is an illustration of a graphical user interface (GUI) of music content set to 100% as a duty cycle variable.

FIG. 10 is an illustration of a graphical user interface (GUI) of talk, music, news and, sports content set to 25% each as a duty cycle variable.

FIG. 11 is an illustration of a graphical user interface (GUI) of news and sports content set to 50% and talk and music content to 0% as a duty cycle variable.

FIG. 12A is a schematic representation of hardware-controlled knob set to 50% music content and 50% talk content as a duty cycle variable.

FIG. 12B is a table showing examples of services, formats, categories, and subcategories, in accordance with some embodiments.

FIG. 12C is an illustration of a GUI for user selection of services, formats, categories, and subcategories, in accordance with some embodiments.

FIG. 12D is an illustration of a GUI on a user device for user selection, in accordance with some embodiments.

FIG. 12E is a block diagram of a system to facilitate personalized digital content, in accordance with some embodiments.

FIG. 12F is a block diagram of a system including an intermediate server to facilitate personalized digital content, in accordance with some embodiments.

FIG. 13 is a schematic representation of hardware-controlled knob set to 75% music content and 25% talk content as a duty cycle variable.

FIG. 14 is a schematic representation of hardware-controlled knob set to 100% music content and 0% talk content as a duty cycle variable.

FIG. 15 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein. “a” and “an” each generally denotes “at least one.” but does not exclude a plurality unless the contextual use dictates otherwise. When used herein to join a list of items. “or” denotes “at least one of the items.” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of systems and methods to facilitate selection and generation of Personalized Digital Content, embodiments of the present disclosure are not limited to use only in this context.

The present subject matter provides for user selection of content to be delivered to the user's personal device. An interface is provided on the user's personal device to enable the selection. In one basic example, the interface is configured to provide for user selection between types of audio content, such as music and talk, and the user can select a percentage of each (such as 75% music and 25% talk), which is referred to herein as the user's “mix.” The user may also select a period of time for the mix, such as an hour, in some embodiments. The present subject matter then obtains the audio content and presents the audio content to the user over the period of time using the mix (in this example, the user would receive 45 minutes of music and 15 minutes of talk content over the one hour period). More complex examples are discussed below, such as providing for selection of video, photos or other types of content to be added to or blended with the mix. The interface can be configured in a number of displays, including but not limited to a knob type display, equalizer-type sliders, pie charts, racks, or other displays that enable the user to interact with the display to select percentages of content and periods of time for delivering the selected percentages of content.

The present subject matter provides the advantage of being implemented with or without a dedicated application to provide the display, selection and content generation, as the subject matter can be implemented within a digital service provider system (such as Spotify, for one nonlimiting example). In addition, the present subject matter provides additional advantages, such as the ability to respond to external signals, sensors, or data to adjust the time period or mix ratio. In various nonlimiting examples, the content provided to the user can be interrupted for push notifications, for weather alerts, for calendar events such as holidays, or for the start or end of scheduled or non-scheduled events such as sporting events or concerts. Other types of content interrupts can be provided without departing from the scope of the present subject matter.

Disclosed herein, among other things, are systems and methods to facilitate selection and generation of personalized digital content, sometimes referred to herein as a “content controller.” In various embodiment of the present system or method, a display is provided on a graphical user interface (GUI) of at least one user device, the display including an interactive portion for the user to select percentages of a plurality of digital content types from at least one server. A user selection is received corresponding to two or more percentages according to two or more digital content types. Digital content associated with the two or more digital content types is retrieved from a database associated with the at least one server. Personalized digital content is generated based on the two or more digital content types according to the two or more percentages by stitching the two or more digital content types, or stitching the retrieved digital content, according to the user selection. The personalized digital content is transmitted to the least one user device as a digital stream for playback on the user device.

According to various embodiments, the content controller of the present subject matter can reside completely within a content provider's network, without the use of an external application. For example, the present content controller can be used by a streaming service in its proprietary network (software and/or hardware) to enhance the GUI presented to a user (customer or consumer). Thus, the content controller of the present subject matter may be a standalone application (installed on a user device or a dedicated server), or the content controller may be built in to a content provider's (such as a streaming music service's) interface, or may be a combination of the two.

In one embodiment, the consumer content controller includes an application installed in a user device such as a smart phone, laptop, etc. In another embodiment, the user can be offered the same functionality with the streaming content provider (e.g., Spotify) application, without a separate application installed on the user device. Thus, the content controller may be utilized exterior to the streaming content application as well as being provided as a feature inside of the streaming content application platform. In various embodiments, the content controller of the present subject matter can be programmed by a user to stream widely varying content, a plurality of categories, and do so programmably over time, according to the users wishes.

In some embodiments, the present disclosure refers to digital content providers such as Spotify, YouTube, Instagram, iHeart Radio, Facebook, Google Play. Amazon Music or Apple Music/iTunes. These providers are also referred to herein as streaming content application platforms, digital content services, web pages, pages, streaming platforms, media asset distributors, on-demand streaming services, and digital service providers (DSPs).

In some embodiments, the present disclosure refers to consumer content, such as consumer audio, video, text, and picture content. This consumer content is also referred to herein as intellectual property (IP) assets, media IP assets, digital content, and digital formats.

The content controller can mix for delivery to the consumer audio content in categories such as News, Music (and types of music, Rock, Metal, Rap, etc.), Talk, Sports, Religion. Weather, and so forth.

The content controller can mix for delivery to the consumer in the Text and Picture category, such a mix of chosen pages (for instance in “Facebook™”) as such pages and pictures as Family Members, Humor, Baby or Infant, Friends, Politics (specific politicians or parties in such), Sports, Events, Animals and Vacations, Memes, News and so forth.

The content controller can mix for delivery to the consumer in the Audio-Video category, such a mix of chosen pages (in this example “YouTube™”) as such video categories as Music. Gaming, News. Films, Fashion. Sports, Humor. Politics, Memes, and so forth.

Regarding the example of the technology of on-demand streaming music, or user selectable cable music, or online web-provided music or web radio stations, (the same is applicable for any digitally stored audio or video or text service that has a plurality of consumer “content” as described above) such as spoken conversation, podcasts, as in Talk Radio—“Talk” or “T” and Music and Songs, here “Music” or “M”, such as streaming music services as Spotify provides, whether or not accompanied by video) often each song selection length is between 10 seconds and 10 minutes or more, with an average about 3-5 minute long songs, and there is a choice the consumer often desires to make, that choice is typically whether to listen to Talk content, or Music content. Or continually switch between either, over the listening day or hour.

One implementation of content balancer, or content mix control innovation, or content controller in this case of audio content (with this innovation additionally applicable in this document for application for text, pictures or audio-video content) is a user interface (GUI) or hardware controlled virtual real “Knob” with three axis, that the user of the content source can adjust to give a specific balance of Music and Talk (for instance) listening, as well as to determine how long the period or duty cycle of talk—music will be.

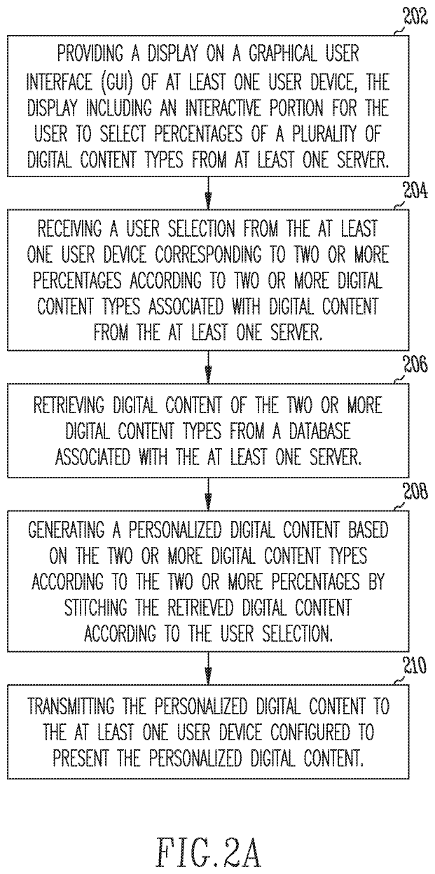

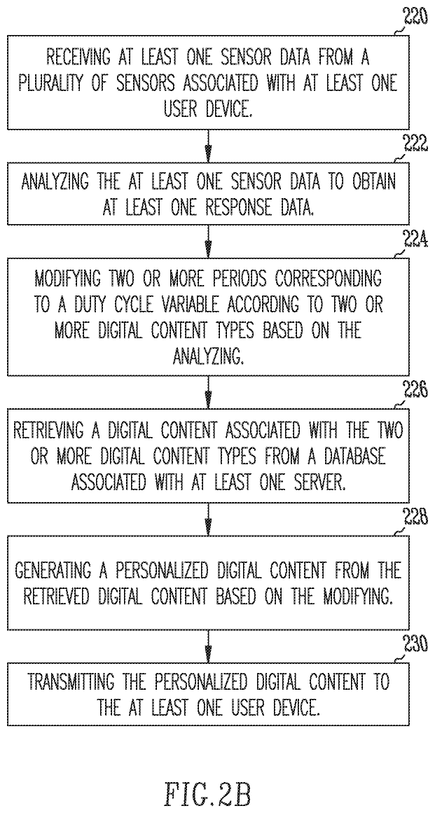

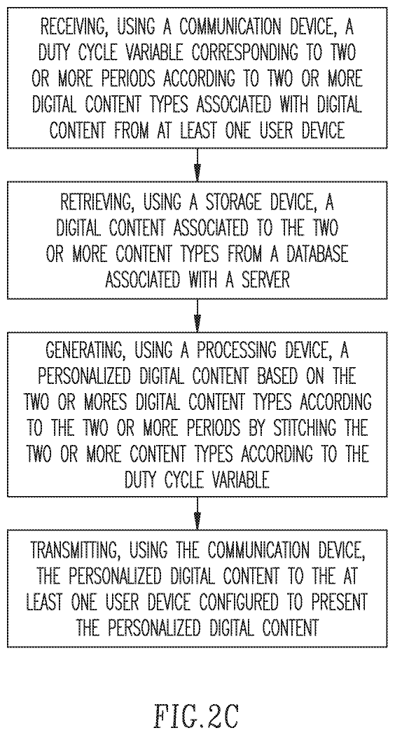

FIG. 2A shows a flowchart of a method to facilitate the selection and generation of personalized digital content, in accordance with some embodiments. A processor provides a display on a graphical user interface (GUI) of at least one user device, the display including an interactive portion for the user to select percentages of a plurality of digital content types from at least one server, at step 202. At step 204, the processor receives a user selection from the at least one user device corresponding to two or more percentages according to two or more digital content types of the plurality of digital content types from the at least one server, wherein the two or more percentages have a sum of one hundred percent. At step 206, the processor retrieves digital content associated with the two or more digital content types from a database associated with the at least one server, and generates a personalized digital content based on the two or more digital content types according to the two or more percentages by stitching the retrieved digital content according to the user selection, at step 208. The processor transmits the personalized digital content to the at least one user device configured to present the personalized digital content, at step 210.

According to various embodiments, the two or more digital content types include one or more digital formats, where the digital formats include video, photographs, text, or audio. The categories of the audio include music and talk, in some embodiments. In various embodiments, subcategories of the music include rock, country, jazz, and hip hop. Subcategories of the talk include news, weather, and sports, in various embodiments. The interactive portion includes an image of one or more knobs that can be turned to select percentages, in various embodiments. In various embodiments, the interactive portion includes an image of one or more sliders that can be moved to select percentages. The at least one server is affiliated with a digital content provider, in some embodiments. In various embodiments, the digital content provider includes one or more of Spotify. YouTube, Instagram, iHeart Radio, Facebook, Google Play, Amazon Music or Apple iTunes. In some embodiments, the content is not stitched together, but merely sent to the user device subsequent to the ending of the previous content.

The content controller of the present subject matter can be configured to provide the ability to respond to external signals, sensors, or data to adjust the time period or mix ratio. In various nonlimiting examples, the content provided to the user can be interrupted for push notifications, for weather alerts, for calendar events such as holidays, or for the start or end of scheduled or non-scheduled events such as sporting events or concerts. Other types of content interrupts can be provided without departing from the scope of the present subject matter. The user's mix can then be adjusted based on the length of the interrupt, in some embodiments. The mix is not adjusted based on the length of the interrupt, in other embodiments. The content controller is configured to receive data or signals from the user device or from external sources to provide for scheduling the delivery of content according to the user selections, or to modify the mix of the current or future user selections, in various embodiments.

According to some embodiments, a computer system is provided including a processor and a non-volatile memory-based storage device connected to the processor comprising instructions that, when executed on the processor, configure the processor to provide a display on a graphical user interface (GUI) of at least one user device, the display including an interactive portion for the user to select percentages of a plurality of digital content types from at least one provider. The processor receives a user selection from the at least one user device corresponding to two or more percentages according to two or more digital content types from the at least one provider, wherein the two or more percentages of each content type have a sum of one hundred percent. The processor retrieves digital content associated with the two or more digital content types from a database associated with the at least one provider. The processor generates a personalized digital content based on the two or more digital content types according to the two or more percentages by stitching the retrieved digital content according to the user selection. The processor transmits the personalized digital content to the at least one user device configured to present the personalized digital content.

The processor is associated with the at least one provider, in various embodiments. In some embodiments, the processor is external to the at least one provider. The display includes an interactive portion for the user to select percentages of a plurality of categories associated with digital content from at least one provider, in various embodiments. In some embodiments, the display includes an interactive portion for the user to select percentages of a plurality of subcategories associated with digital content from at least one provider. The processor is configured to transmit the personalized digital content to the at least one user device for a programmable period of time, in various embodiments. In one embodiment, a default value of the programmable period of time is one hour. The display includes an interactive portion for the user to select a percentage to which the digital content is interleaved, in various embodiments.

FIG. 2B shows a flowchart of a method to facilitate the generation of personalized digital content, in accordance with some embodiments. The method includes receiving, using a processor, at least one sensor data from a plurality of sensors associated with at least one user device, at step 220, and analyzing, using the processor, the at least one sensor data to obtain at least one response data, at step 222. At step 224, the processor modifies two or more periods corresponding to a duty cycle variable according to two or more digital content types based on the analyzing, and retrieves a digital content associated with the two or more digital content types from a database associated with at least one server, at step 226. At step 228, the processor generates a personalized digital content from the retrieved digital content based on the modifying, and transmits the personalized digital content to the at least one user device, at step 230.

In some embodiments, the method further includes storing, using the processor, data of the selection of sources, the source ratios, the mix cycle duration, etc. collectively (or individually, in whole or in part) as a mix preset accessible by the at least one user device. The method further includes distributing, using the processor, the mix preset to a plurality of users selected by the at least one user device, in various embodiments. The ability to share presets makes the content controller of the present subject matter more appealing. The user may also share the personalized digital content with other users, by directing the stream of personalized digital content to other users, either simultaneously or with a delay, or with an option for the other users to play the stream of content at a chosen time. Thus, the present subject matter advantageously provides an option on the GUI for the user to share mix presets (the user selections) and/or share the personalized digital content generated according to the mix presets. The user may select other users with whom to share from the GUI, in various embodiments. In addition, the GUI provides the option to the user to store the mix presets for future sharing or reuse by the user, in various embodiments.

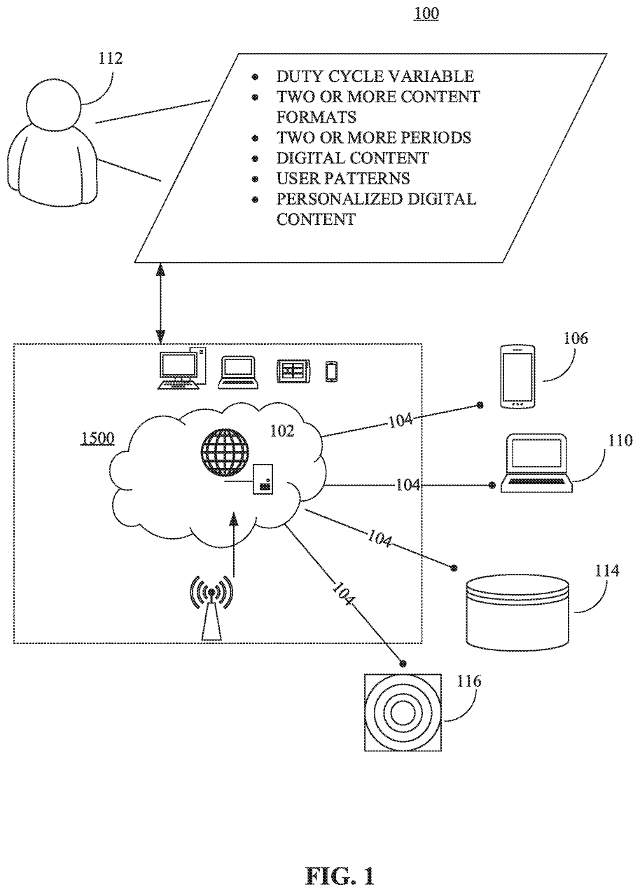

FIG. 1 is an illustration of an online platform 100 consistent with various embodiments of the present disclosure. By way of non-limiting example, the online platform 100 to facilitate generation of Personalized Digital Content may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users and administrators. Accordingly, in some instances, electronic devices operated by the one or more relevant parties may be in communication with the online platform 100.

A user 112, such as the one or more relevant parties, may access the online platform 100 through a web-based software application or browser. The web-based software application may be embodied as, for example, but not be limited to, a website, a web application, a desktop application, and a mobile application compatible with a computing device 900.

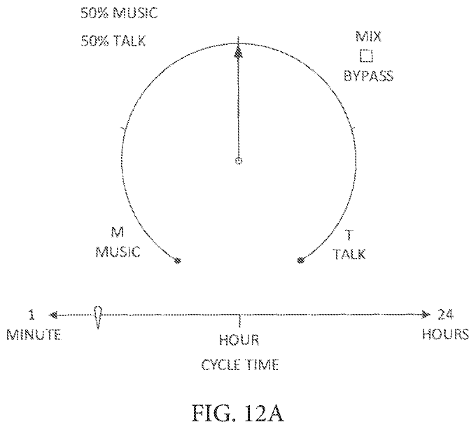

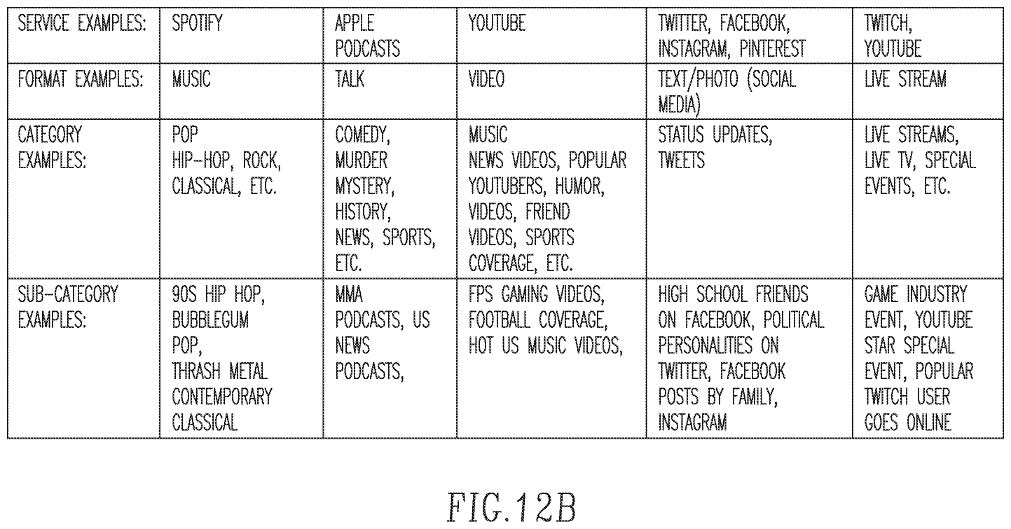

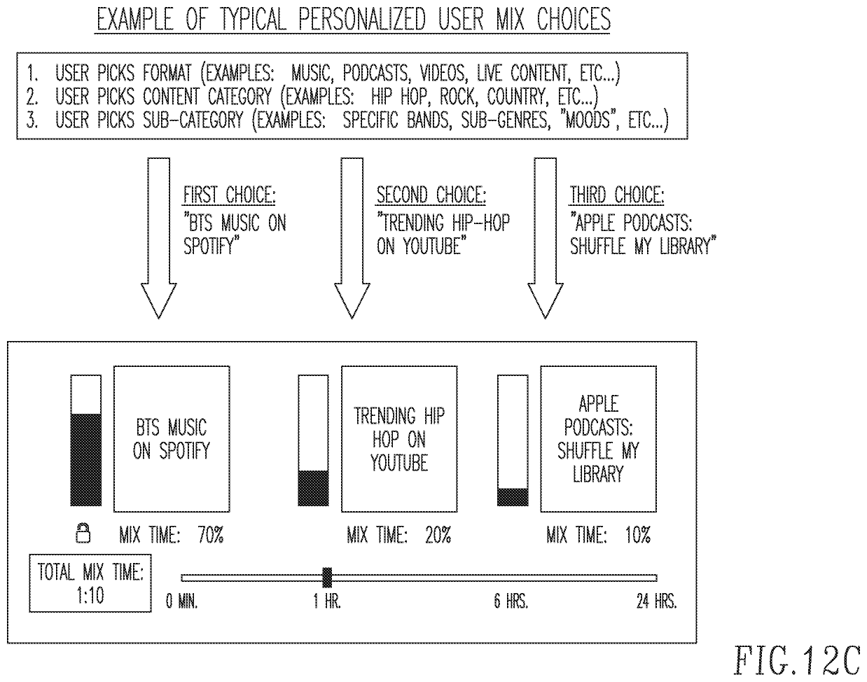

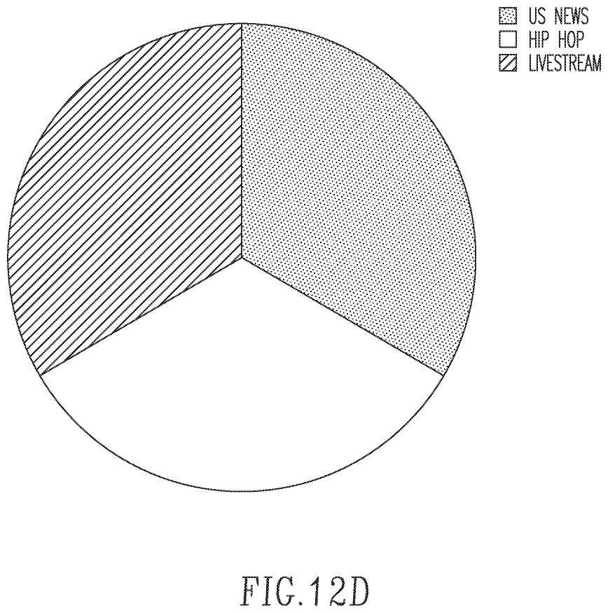

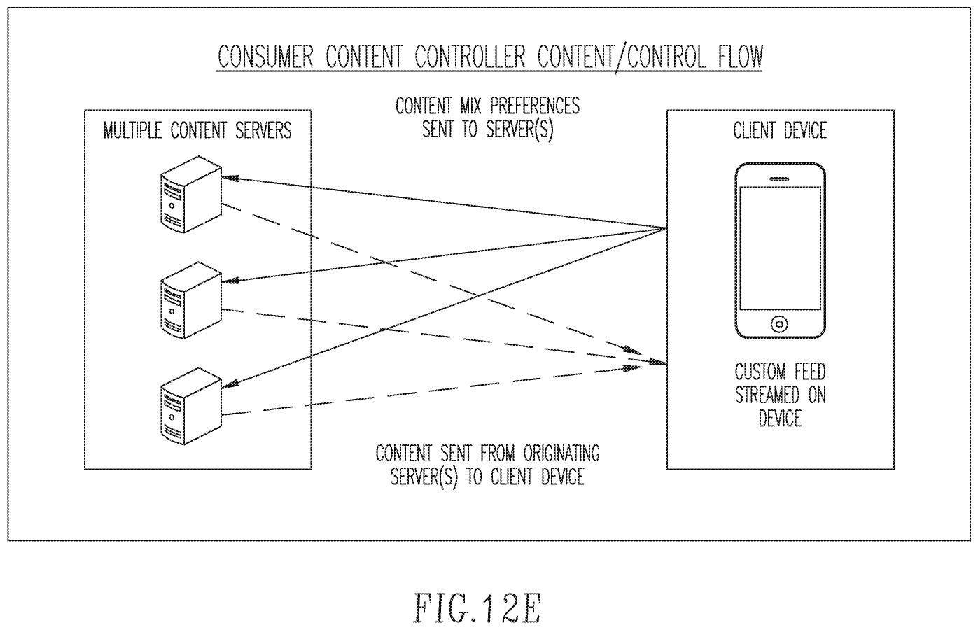

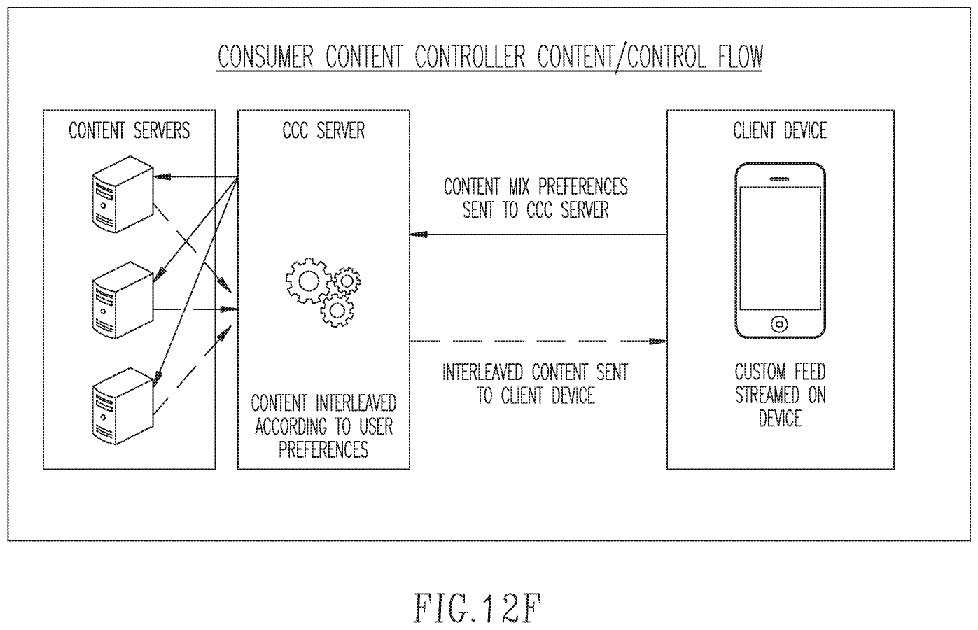

FIG. 2C shows a flowchart of a method to facilitate the generation of personalized digital content, in accordance with some embodiments. Accordingly, the method may include a step of receiving, using a communication device, a duty cycle variable corresponding to two or more periods according to two or more digital content types from at least one user device. Further, the duty cycle variable is the time period of the two or more digital content types. Further, the duty cycle variable may be in percentage determining a time duration of the two or more periods. Further, the two or more digital content types may exist in the form of binary data in the database. Further, the database may be associated with a server. Further, the digital content may include, but not limited to, spoken words, conversations, podcasts (“Talk” or “T”) and music and songs (“Music” or “M”). Further, the at least one user device may be associated with at least one user. Further, the at least one user device may include, but not limited to a smartphone, a tablet, a PC, a smartwatch, etc. Further, in an instance, the user may input the desired duty cycle variable and digital content by interacting with the user device. Further, for instance, as shown in FIG. 12, the input may also be implemented by using a hardware-controlled knob. Further, the hardware-controlled knob may include three or more controlled axes and a slider. Further, the three or more controlled axes may be to input the duty cycle variable. Further, the slider may be to input a cycle time, combined of the two or more periods.

Further, the method may include a step of retrieving, using a storage device, a digital content associated the two or more content types from a database associated with a server. Further, the server may be the network that manages the digital content. Accordingly, the storage device may retrieve the two or more period associated digital content from the database as input by the user device associated with the at least one user. For example, in an instance, the user may input talk content and music content by interacting with the at least one user device or hardware-controlled knob. Accordingly, the storage device may retrieve the talk content and music content from the database.

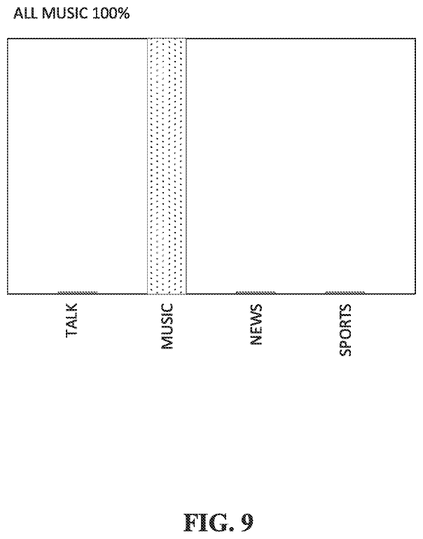

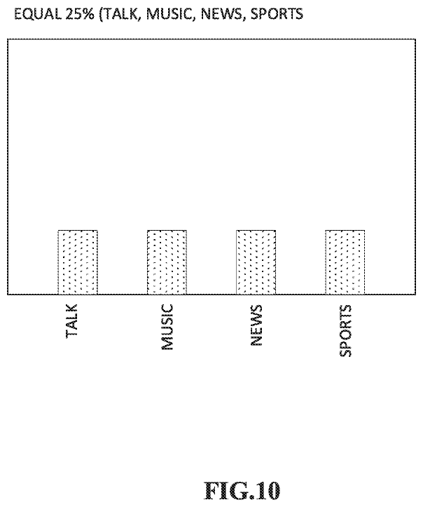

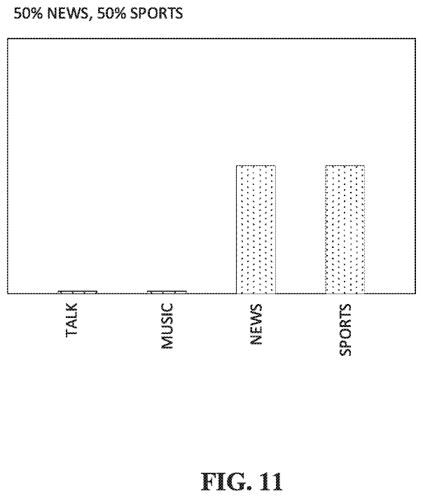

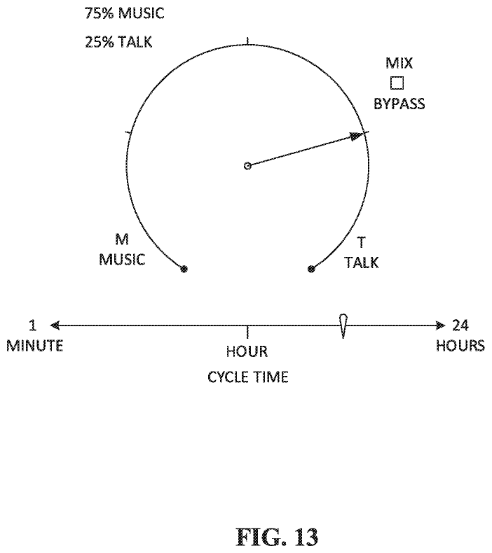

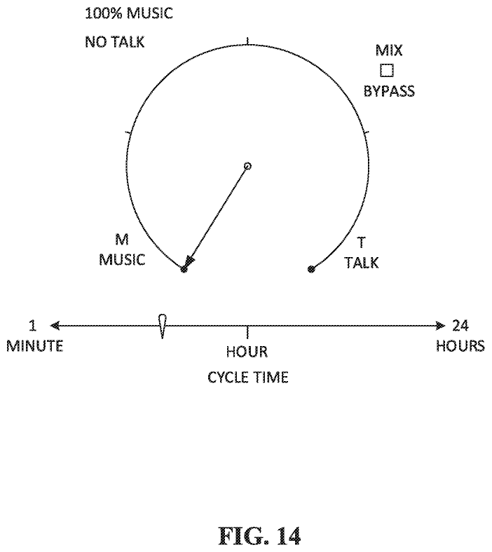

Further, the method may include a step of generating, using a processing device, a personalized digital content based on the two or more digital content types according to the two or more periods by stitching the two or more digital content types according to the duty cycle variable. Further, the stitching of the two or more digital content types may be smooth and natural sounding. For example, in an instance, the user may be input the duty cycle variable to 50% of the 8 minutes' cycle and the digital content of Talk and Music. Accordingly, a personalized digital content is followed by 3-5 minutes of Talk and 5-3 minutes of Music. Accordingly, in an instance, the user may input the two or more digital content by interacting with the user device which may include, but not limited to, podcasts, music, news, and sports at 10%, 50%, 20%, and 20% respectively for 100 minutes' cycle. Further, the personalized digital content may include 10 minutes of podcasts, 50 minutes of music, 20 minutes of news, and 20 minutes of sports, respectively. Further, for instance, the graphical user interface (GUI) as shown in FIG. 9, in which a user may set the music content to 100% as a duty cycle variable by interacting with the user device. Accordingly, the podcasts, music, and news content may automatically adjust to 0% to get a balance of the digital content to the user. Further, for instance, the GUI as shown in FIG. 10, an equal balance of talk, music, news, and sports content to 25% on the basis of user input. Further, for instance, the GUI as shown in FIG. 11, an equal balance of news and sports content to 50% and, talk and music content to 0% on the basis of user input. Further, for instance, as shown in FIG. 12A, a hardware-controlled knob which may be adjusted by the user to 50% music and 50% talk. Further, for instance, as shown in FIG. 13, the hardware-controlled knob which may be adjusted by the user to 75% music and 25% talk. Accordingly, for instance as shown in FIG. 14, the hardware-controlled knob which may be adjusted by the user to 100% music and 0% talk.

Further, the method may include a step of transmitting, using the communication device, the personalized digital content to the at least one user device configured to present the personalized digital content. Accordingly, the user may stream the personalized digital content on the at least one user device.

According to various embodiments, the consumer content control system of the present subject matter provides a user controlled pre-programmed periodic mixer and server of multiple, automatically served formats and categories. According to various embodiments, the consumer content control system of the present subject matter retrieves, interleaves, and serves media content to a user in a “content mix” according to the user's source and content preferences. FIG. 12B is a table showing examples of services, formats, categories, and subcategories for user selection, in accordance with some embodiments. In various embodiments, the consumer content control system mixes multiple streams according to a user-determined ratio. The resulting consumer mixed content is called a mix (see FIG. 12A for example).

FIGS. 12C-12D are illustrations of a GUI for user selection of services, formats, categories, and subcategories, in accordance with some embodiments. In various embodiments, the consumer content control system provides for user selection of their content mix preferences using a channel rack. Under each source channel, the user selects a content type. In various embodiments, the user selects a channel's content type from a data tree arranged in the following form: media service->(media) format->category->sub-categories. Thus, the interface provides for a tiered selection format for selecting content type by the user. In some embodiments, the selection of a media service changes the display to provide on the display available formats from the selected media service. Likewise, in some embodiments, the selection of formats changes the display to provide on the display available categories of the selected format. Similarly, the selection of a category changes the display to provide on the display available subcategories of the selected category, in some embodiments. The interface can be configured using a number of display elements, either alone or in combination, including but not limited to a knob type element, equalizer-type sliders, pie charts, racks, or other display elements (some of which that are depicted in the accompanying drawings) that enable the user to interact with the display to select percentages of content and periods of time for delivering the selected percentages of content. Other display formats for user selection can be used without departing from the scope of the present subject matter. The interactive display can be used for selection of one or more of digital content provider, format, category, and subcategory of content, as well as period of time and types of interruptions permitted or blocked, in various embodiments.

In the embodiment of FIG. 12C, a user first picks a format such as music, podcasts, photographs, text, videos, or live content. Other formats can be used without departing from the scope of the present subject matter. The format selection can be accompanied with, or prior to, or after a selection of a media service provider, in some embodiments. The user then selects a content category such as music (hip hop, rock, country, or other music genre) or talk. Other categories can be used without departing from the scope of the present subject matter. The user subsequently selects a sub-category such as specific bands, sub-genres, or moods. Other sub-categories can be used without departing from the scope of the present subject matter. The selections can be made in any order, in various embodiments. The user makes multiple selections of media service provider, format, category and subcategory, in various embodiments. The multiple selections are part of a rack of choices, and the user then adjusts a portion of the display to select a percentage of each choice to be part of a user mix, in various embodiments. The percentages have a sum of one hundred percent. In some embodiments, the user selects a time period over which the mix will be delivered. In the depicted embodiment of FIG. 12C, the time period is selected to be one hour and ten minutes. The user has a selection to start the playing of the mix immediately, or after a delay period, or upon a schedule (date/time), in various embodiments. The user can also select to repeat the mix a number of times from the interface, in some embodiments. In various embodiments, the mix will repeat automatically after expiration of the selected time period. The user can lock in selections of the mix using a selectable portion of the interface, in various embodiments. The service provider, format, category and subcategory provide for a tiered selection process of digital content type by the user, in various embodiments.

In FIG. 12C, the size of the bars of the slider/equalizers are proportional to the percentage of playing time of each type of content within the selected time period. In various embodiments, changing one slider cause the other sliders to adjust proportionally. In some embodiments, a slider can also be locked such that it will not vary in percentage size when changing the other sliders (with three or more sliders/selections). A global setting of mix duration determines the minimum period in which the mix is streamed before repeating, in various embodiments. Setting the mix duration to zero is the same as pausing the playback of the mix. The mix can also be represented as a pie chart with adjustable pie slices (instead of using sliders or knobs), as shown in FIG. 12D. A user taps a slice within the chart to begin adjusting mix proportions, in various embodiments. The user can select the order of each selection based on first choice, second choice, etc., in various embodiments. In other embodiments, the selections may be presented to the user in a random order. In some embodiments, the selections may be presented to the user in an overlapping manner, such as a music selection playing during a display on the user device of photos from a social media account. The user may select to have overlapping content from the interface using a selectable portion of the display, or the overlapping may be done automatically if the content controller identifies formats or categories that lend themselves to overlapping, in various embodiments.

In various embodiments, the user will be able to make their selection at any level of the tree, from a very broad level to a very narrow level: e.g., “serve me Spotify content of any kind” (broad) to “serve me mid 90s west coast Hip Hop on Spotify” (narrow). After selecting more than one channel, the user can select the content play distribution they wish to have on their mix, e.g., 50% from channel A, 50% from channel B. or 33% from channel A, 33% from channel B, and 33% from channel C. and so forth. These ratios are the duty cycles of the different streamed content, in various embodiments. In one embodiment, the entirety of the user's selections is called the mix. The default mix time is one hour, in various embodiments. After one hour, the chosen distribution will recur (with new content of the specified type in each ‘broadcast slot’), in an embodiment. The user can adjust the mix time at any point, in various embodiments. In one example, a user may select 75% music and 25% news, and this 75-25 stream “block” will then repeat after one hour (by default). Changing the mix time to 40 minutes, in the 75-25 mix example, will yield a mix of 30 minutes of Music and 10 minutes of News.

According to various embodiments, the user will also be able to select a chosen (0-100) amount of “Shuffle” (a variable which determines the degree to which content is interleaved, analogous to how well a deck of cards has been shuffled). Users will also be able to save their mixes as mix presets and share them with other users, in various embodiments. In some embodiments, “expert” mix makers could distribute their best mixes through a consumer content control system App service or on social media. Example mix presets might include: Hip-Hop and Rockin' Kicks, w/short News and Sports Results. YouTube Countryside with Lullabies, podcasts with text-to-speech sports results, etc.

As depicted in FIG. 12D, modifying one slider causes the others to adjust proportionately, always summing to 100% in an embodiment. In another embodiment, a slider can be locked such that it will not vary when other sliders are changed (when three or more sliders/selections are available in the channel rack). A global setting “mix duration” determines a minimum time period in which the mix is assembled. The “min” duration results in a constant shuffle, in an embodiment. The “max” duration can be user selected or set to a default. For example, the max duration may be two hours before changing to another content type. FIG. 12D further illustrates that the mix can be represented on the user GUI as an adjustable pie chart, in one embodiment.

In various embodiments, the user does not by default choose percentages on every level of the content tree of FIG. 12C, but the user may land on a certain level and that gets passed to the channel rack (where a percentage is assigned to the levels at that time).

FIGS. 12E-12F are block diagrams of systems to facilitate personalized digital content, in accordance with some embodiments. According to various embodiments, the present content controller includes an application that can fetch media server content directly by using an API or other means (using source server database metadata for content categorization), as shown in FIG. 12E. In other embodiments, the application sends user mix preferences to an intermediate server, which then fetches, interleaves, and delivers the mix to the user, as shown in FIG. 12F, which lightens the processing required on a device hosting the present content controller application.

According to various embodiments, the content controller supports mixing of multiple types of content simultaneously as well as mixing between different content formats (e.g., audiobook over quiet piano music or music—with an abstract visualization, followed by a video). The user is also able to control the volume balances between audio sources in simultaneous and other mixes, in various embodiments. In some embodiments, the content controller application visually displays text or renders it in text-to-speech form through text-to-speech conversion of some types of content (alone or simultaneous with other content).

In various embodiments, the consumer content control server is configured to meld non-synchronized (e.g., live) content including sounds, talk, texts, pictures, videos or musical events which occur at an undefined time into the mix by using automated tools such as fade outs, fade-ins, ducking, crossfades and other automated tools. These features will apply to both pre-programmed and live events in all formats, in various embodiments. The terms “fade in,” “ducking,” etc., refer to digital signal processing (DSP) tools provided by the content controller for a smooth consumer experience with certain unpredictable (asynchronous) content packets. These events might include a weather alert that interrupts a music broadcast, or a live concert (which the user has expressed preference for) which interrupts a pre-recorded talk show. When switching these asynchronous media into the mix, the content controller of the present subject matter automatically applies “crossfades” or other means of blending in the content, in various embodiments. In various embodiments, the content controller uses artificial intelligence (AI) and/or metadata to detect good “interrupt” points in certain types of content, e.g., silent zones on live streams, a long blank video screen, empty text pages, etc., to trigger a switch to another channel of the mix. The content controller constructs content metadata using AI if no other metadata is available from the originating server, in some embodiments.

In various embodiments, the present content controller provides for head end-oriented, cloud-based streams to be organized to stream sequentially. One or more control paths are used from the consumer device to the content providers to reflect the origin of source material, in various embodiments. A control path to each of a plurality of content providers is used by the content controller, in various embodiments, to enable the user to select content segments to be sequentially and programmatically streamed to the user device.

According to various embodiments, the content controller of the present subject matter can reside completely within a content provider's network, without the use of an external application. For example, the present content controller can be used by a streaming service in its proprietary network (software and/o hardware) to enhance the GUI presented to a user (customer or consumer). Thus, the content controller of the present subject matter may be a standalone application (installed on a user device or a dedicated server), or the content controller may be built in to a content provider's (such as a streaming music service's) interface, or may be a combination of the two.

In one embodiment, the consumer content controller includes an application installed in a user device such as a smart phone, laptop, etc. In another embodiment, the user can be offered the same functionality with the digital content provider (e.g., Spotify, Twitter) application, without a separate application installed on the user device. Thus, the content controller may be utilized exterior to the streaming content application as well as being provided as a feature inside of the streaming content application platform. In various embodiments, the content controller of the present subject matter can be programmed by a user to stream widely varying content, a plurality of categories, and do so programmably over time, according to user preferences.

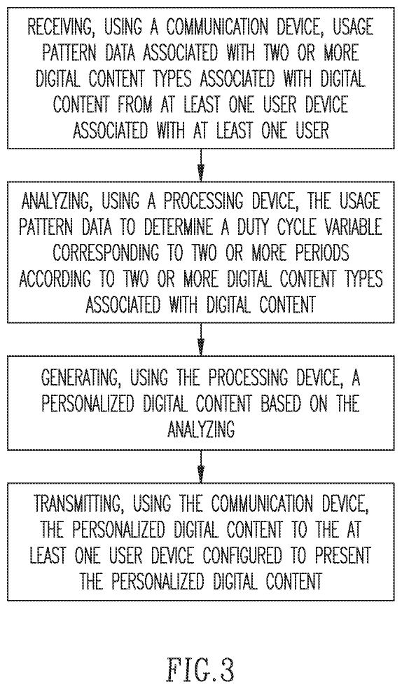

FIG. 3 shows a flowchart of a method to facilitate the generation of personalized digital content, in accordance with some embodiments. Accordingly, the method may include a step of receiving, using a communication device, usage pattern data associated with two or more digital content types from at least one user device associated with at least one user. Further, the usage pattern data may include, but not limited to, session time, session length, ideal digital content, etc. Further, the session time may be a duration of a day which may be morning or evening of the at least one user. Further, the session length may be a duration of the session which may be 5 minutes, 12 minutes, etc., of the at least one user. Further, the ideal digital content may be the digital content which the user may listen on a regular basis. Further, the digital content may also be sub-categorized. For example, the music may include, but not limited to classic, pop, rock, jazz, folk, etc. Accordingly, sports may include but not limited to baseball, tennis, basketball, etc. Accordingly, news may include soft news and hard news. Further, the at least one user device may include, but not limited to a smartphone, a tablet, a PC, a smartwatch, smart home or smart business devices, etc.

Further, the method may include a step of analyzing, using a processing device, the usage pattern data to determine a duty cycle variable corresponding two or more periods according to two or more digital content types. Further, determining the duty cycle and the two or more digital content types from the usage pattern data using deep learning i.e., AI-generated. Further, deep learning may help advertisers, wishing to advertise. Further, deep learning may be beneficial in determining the user interests and may help the advertisers in targeting the right user. Further, the advertising may be as dictated by the at least one user or advertising authority. For example, in an instance, a user may be interested in listening to pop music. Accordingly, using deep learning, the user interests may be known by analyzing the usage pattern data of the user. Further, the user interests may help the pop music producers to target the user by advertising an upcoming pop music.

Further, the method may include a step of generating, using the processing device, a personalized digital content based on the analyzing. For example, in an instance, analyzing the usage pattern data of a user corresponding to music and news content for 20 minutes every morning of a 40% duty cycle variable. Accordingly, a personalized digital content may consist of 8 minutes of music and 12 minutes of news.

Further, the method may include a step of transmitting, using a communication device, the personalized digital content to the at least one user device configured to present the personalized digital content. Accordingly, the user may stream the personalized digital content on the at least one user device.

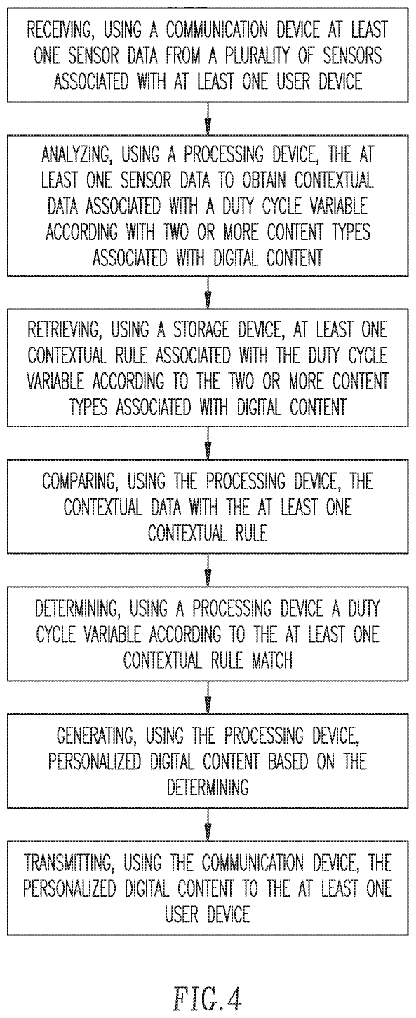

FIG. 4 shows a flowchart of a method to facilitate the generation of personalized digital content based on contextual rules, in accordance with some embodiments. Accordingly, the method may include a step of receiving, using a communication device, at least one sensor data from a plurality of sensors associated with at least one user device. Further, the plurality of sensor data may include data associated with the at least one user which may determine the user behavior, user movement, user environment, etc. Further, the plurality of sensors may include, but not limited to, proximity sensor, motion sensor, image sensor, etc. Further, the at least one user device may be associated with at least one user. Further, the at least one user device may include, but not limited to a smartphone, a tablet, a PC, a smartwatch, smart home and business devices, etc.

Further, the method may include a step of analyzing, using a processing device, the at least one sensor data to obtain contextual data associated with a duty cycle variable according to two or more digital content types. Further, in an instance, a user may be jogging/nature walk in the morning as detected by the user movement using a motion sensor. Further, jogging/nature walk corresponds to a contextual data. Further, the motion sensor may be used for monitoring the user device movement, such as tilt, shake, rotation, or swing.

Further, the method may include a step of retrieving, using a storage device, at least one contextual rule associated with the duty cycle variable according to the two or more digital content types. Further, the contextual rule may include defined rules associated with a database. Further, the database may be associated with a server. Further, the server may be the network that manages the contextual rules. For example, in an instance, a jogging/nature walk with earbuds may be associated with 100% of Music and 0% of Talk. Further, in an instance, a user may wish to drift off to sleep with 90% of Talk content and 10% of Music content.

Further, the method may include a step of comparing, using the processing device, the contextual data with the at least one contextual rule. For example, in an instance, the jogging/nature walk activity may correspond to a contextual data. Further, jogging activity may be associated with a contextual rule. Further, the contextual rule may be to stream 100% of Music and 0% of Talk. Accordingly, comparing the jogging activity and the contextual rule.

Further, the method may include a step of determining, using a processing device, a duty cycle variable according to the at least one contextual rule match. Further, the duty cycle variable corresponding to two or more periods according to two or more digital content types.

Further, the method may include a step of generating, using the processing device, personalized digital content based on determining. Further, the personalized digital content may be in accordance with taste, nature of listening, and desire of the user.

Further, the method may include a step of transmitting, using the communication device, the personalized digital content to the at least one user device. Accordingly, the user may stream the personalized digital content on the at least one user device.

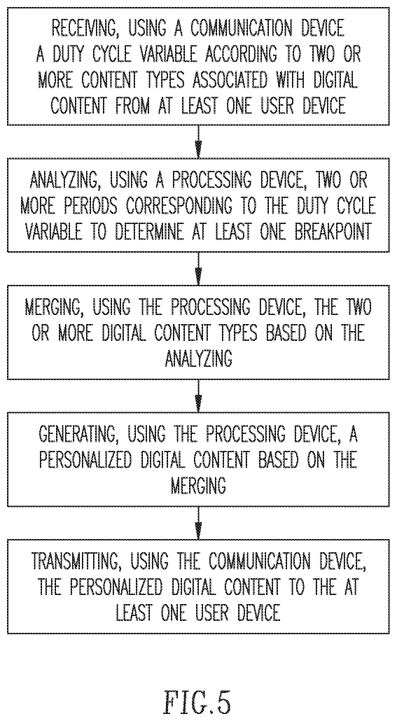

FIG. 5 shows a flowchart of a method to facilitate the merging of two or more content types, in accordance with some embodiments. Accordingly, the method may include a step of receiving, using a communication device, a duty cycle variable according to two or more digital content types from at least one user device associated with at least one user. Further, the at least one user device may include, but not limited to a smartphone, a tablet, a PC, a smartwatch, smart home or business devices, etc. Further, in an instance, the two or more periods corresponding to Music and Talk content.

Further, the method may include a step of analyzing, using a processing device, the two or more periods corresponding to the duty cycle variable to determine at least one breakpoint. Further, the method may include a step of intelligently identifying the at least one breakpoint. Further, the at least one breakpoint may be a point of change in program material.

Further, the method may include a step of merging, using the processing device, two or more digital format based on the analyzing. Further, the merging of the two or more digital content types may be based on automatic deep learning i.e., AI-generated. Further, in an instance, in talk and music mix ratio, the music may fade in or fade out at a realistic and entertainment intelligent point. Further, the fade in or fade out may result in smooth and natural sounding switch between the content.

Further, the method may include a step of generating, using the processing device, a personalized digital content based on the merging. Further, the personalized digital content may be generated based on the merging of the two or more digital content types.

Further, the method may include a step of transmitting, using the communication device, the personalized digital content to the at least one user device. Accordingly, the user may stream the personalized digital content on the at least one user device.

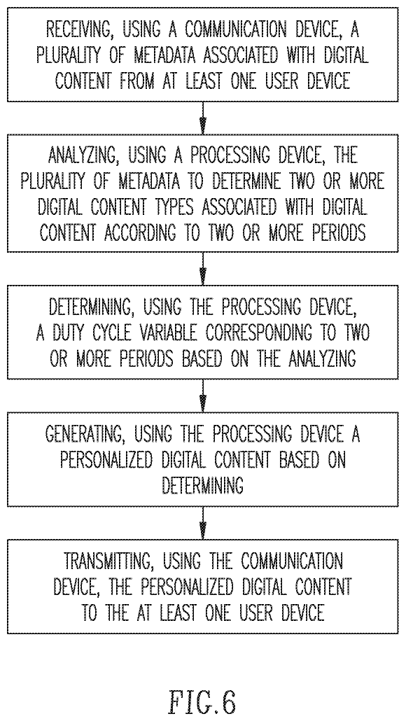

FIG. 6 shows a flowchart of a method to facilitate the generation of personalized digital content based on metadata, in accordance with some embodiments. Accordingly, the method may include a step of receiving, using a communication device, a plurality of metadata associated with digital content from at least one user device. Further, the plurality of metadata may include, but not limited to, file format, author, artist, file size, genre, etc. Further, the at least one user device may be associated with at least one user. Further, the at least one user device may include, but not limited to a smartphone, a tablet, a PC, a smartwatch, smart home and business devices, etc.

Further, the method may include a step of analyzing, using a processing device, the plurality of metadata to determine two or more digital content types according to two or more periods. For example, in an instance, streaming songs by a particular artist on the at least one user device may be implemented by using the artist metadata tag as a filter.

Further, the method may include a step of determining, using the processing device, a duty cycle variable corresponding to the two or more periods based on the analyzing. Further, determining the two or more periods according to two or more digital content types.

Further, the method may include a step of generating, using the processing device, a personalized digital content based on determining. Further, the personalized digital content may be based on the plurality of metadata associated with the digital content.

Further, the method may include a step of transmitting, using the communication device, the personalized digital content to the at least one user device. Accordingly, the user may stream the personalized digital content on the at least one user device.

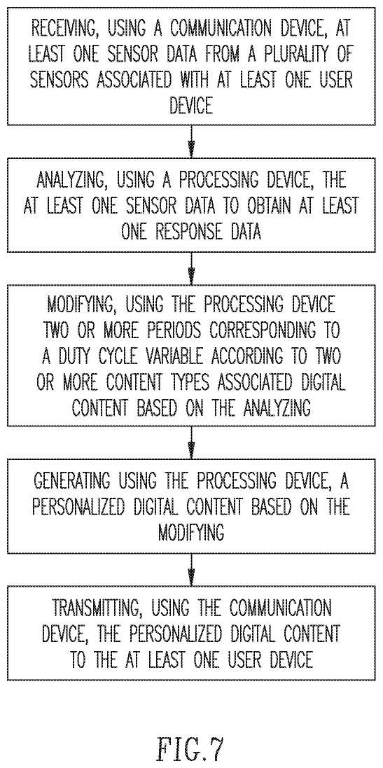

FIG. 7 shows a flowchart of a method to facilitate a personalized digital content based on feedback, in accordance with some embodiments. Accordingly, the method may include a step of receiving, using a communication device, at least one sensor data from a plurality of sensors associated with at least one user device. Further, the sensor may include, but not limited to, proximity sensor, motion sensor, image sensor, etc. Further, the proximity sensor may be used to detect the presence of nearby objects without any physical contact, for monitoring the user environment. Further, the motion sensor may be used for monitoring device movement, such as tilt, shake, rotation, or swing. Further, the image sensor may be used for monitoring user behavior. Further, the at least one user device may be associated with at least one user. Further, the at least one user device may include, but not limited to a smartphone, a tablet, a PC, a smartwatch, etc.

Further, the method may include a step of analyzing, using a processing device, the at least one sensor data to obtain at least one response data. For example, in an instance, the user may be happy corresponding to smiles and facial responses as detected by the image sensor. Further, in an instance, the user may be unhappy corresponding to sadness and fatigue as detected by the image sensor. For example, in an instance, a happy user may be associated with the at least one response data.

Further, the method may include a step of modifying, using the processing device, two or more periods corresponding to a duty cycle variable according to two or more digital content types based on the analyzing. For example, in an instance, a user may be happy, accordingly, the modifications in the duty cycle associated with an increased cycle of the two or more periods. Further, the modification may be on the basis of a contextual rule. Further, the contextual rule may include defined rules associated with a database. Further, the database may be associated with a server. Further, the server may be the network that manages the contextual rules.

Further, the method may include a step of generating, using the processing device, a personalized digital content based on the modifying. Further, the generation of personalized digital content on the basis of user feedback as detected by the plurality of sensors.

Further, the method may include a step of transmitting, using the communication device, the personalized digital content to the at least one user device. Accordingly, the user may stream the personalized digital content on the at least one user device.

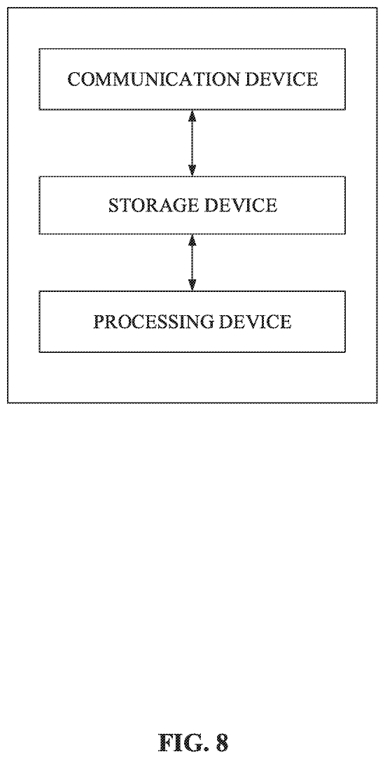

FIG. 8 is a block diagram of a system to facilitate the generation of a customized response based on a context, in accordance with some embodiments. Further, the system may include, a communication device, a storage device, and a processing device.

Further, the communication device may be configured for receiving a duty cycle variable corresponding to two or more periods according to two or more digital content types from at least one user device. Further, the communication device may be configured for transmitting the personalized digital content to the at least one user device configured to present the personalized digital content.

Further, the storage device may be configured for retrieving digital content types from a database associated with a server.

Further, the processing device may be configured for generating a personalized digital content based on the two or more digital content types according to the two or more periods by stitching the two or more content types according to the duty cycle variable.

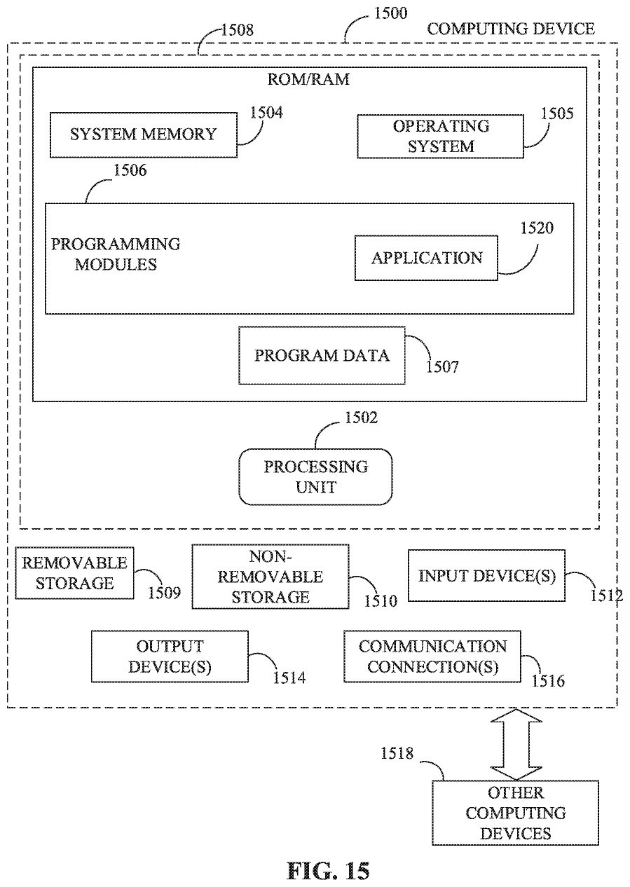

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500's operation. In one embodiment, programming modules 1506 may include image-processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and nonvolatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a location sensor, a camera, a biometric sensor, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520 such as a media player) may perform processes including, for example, one or more stages of methods, algorithms, systems, applications, servers, databases as described above. The aforementioned process is an example, and processing unit 1502 may perform other processes. Other programming modules that may be used in accordance with embodiments of the present disclosure may include machine learning application.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet. or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A method to facilitate the generation of personalized digital content, the method comprising:
providing, using a processor, a display on a graphical user interface (GUI) of at least one user device, the display including an interactive portion for the user to select percentages of a plurality of digital content types from at least one server;
receiving, using a processor, a user selection from the at least one user device corresponding to two or more percentages according to two or more digital content types from the at least one server, wherein the two or more percentages have a sum of one hundred percent;
retrieving, using the processor, digital content of the two or more digital content types from a database associated with the at least one server;
generating, using the processor, a personalized digital content based on the two or more digital content types according to the two or more percentages by stitching the retrieved digital content according to the user selection; and
transmitting, using the processor, the personalized digital content to the at least one user device configured to present the personalized digital content.

2. The method of claim 1, wherein the two or more digital content types include one or more digital formats, wherein the digital formats include video, photographs, text or audio.

3. The method of claim 2, wherein categories of the audio include music and talk.

4. The method of claim 3, wherein subcategories of the music include rock, country, jazz and hip hop.

5. The method of claim 3, wherein subcategories of the talk include podcasts, news, weather and sports.

6. The method of claim 1, wherein the interactive portion includes an image of one or more knobs that can be turned to select percentages.

7. The method of claim 1, wherein the interactive portion includes an image of one or more sliders that can be moved to select percentages.

8. The method of claim 1, wherein the at least one server is affiliated with a digital content provider.

9. The method of claim 8, wherein the digital content provider includes one or more of Spotify, YouTube, Instagram, iHeart Radio, Facebook, Google Play, Amazon Music or Apple iTunes.

10. A computer system, comprising:
a processor; and
a non-volatile memory-based storage device connected to the processor comprising instructions that, when executed on the processor, configure the processor to:
provide a display on a graphical user interface (GUI) of at least one user device, the display including an interactive portion for the user to select percentages of a plurality of digital content types from at least one provider;
receive a user selection from the at least one user device corresponding to two or more percentages according to two or more digital content types from the at least one provider, wherein the two or more percentages have a sum of one hundred percent;
retrieve digital content of the two or more digital content types from a database associated with the at least one provider;
generate a personalized digital content based on the two or more digital content types according to the two or more percentages by stitching the retrieved digital content according to the user selection; and
transmit the personalized digital content to the at least one user device configured to present the personalized digital content.

11. The system of claim 10, wherein the processor is associated with the at least one provider.

12. The system of claim 10, wherein the processor is external to the at least one provider.

13. The system of claim 10, wherein the display includes an interactive portion for the user to select percentages of a plurality of categories associated with digital content from at least one provider.

14. The system of claim 10, wherein the display includes an interactive portion for the user to select percentages of a plurality of subcategories associated with digital content from at least one provider.

15. The system of claim 10, wherein the processor is configured to transmit the personalized digital content to the at least one user device for a programmable period of time.

16. The system of claim 15, wherein the processor is configured to receive external signals or data, and further configured to adjust the time period or the two or more percentages in response to receiving the external signals or data.

17. The system of claim 16, wherein the external signals or data includes one or more of push notifications, weather alerts, calendar events such as holidays, or notifications of a start or end of scheduled or non-scheduled events such as sporting events or concerts.

18. A method to facilitate a personalized digital content based on feedback, the method comprising:
receiving, using a processor, at least one sensor data from a plurality of sensors associated with at least one user device;
analyzing, using the processor, the at least one sensor data to obtain at least one response data;
modifying, using the processor, two or more periods corresponding to a duty cycle variable according to two or more digital content types based on the analyzing;
retrieving, using the processor, a digital content associated with the two or more digital content types from a database associated with at least one server;
generating, using the processor, a personalized digital content from the retrieved digital content based on the modifying; and
transmitting, using the processor, the personalized digital content to the at least one user device.

19. The method of claim 18, further comprising storing, using the processor, the user selections associated with the personalized digital content as a mix preset accessible by the at least one user device.

20. The method of claim 19, further comprising distributing, using the processor, the mix preset to a plurality of users selected by the at least one user device.
